(19) United States
(12) Patent Application Publication
(10) Pub. No.: US 2025/0005053 A1
(43) Pub. Date: Jan. 2, 2025

(54) ANSWER FEEDBACK METHOD AND APPARATUS APPLIED TO LARGE LANGUAGE MODEL

(71) Applicant: Beijing Baidu Netcom Science Technology Co., Ltd., Beijing (CN)

(72) Inventors: Peiguo DONG, Beijing (CN); Fangfang SHI, Beijing (CN); Meiyuan DING, Beijing (CN); Huibin ZHAO, Beijing (CN)

(21) Appl. No.: 18/749,305

(22) Filed: Jun. 20, 2024

(30) Foreign Application Priority Data
Dec. 13, 2023 (CN) 202311714546.9

(51) Int. Cl. G06F 16/332

(52) U.S. Cl. CPC G06F 16/3329

(57) ABSTRACT

A method and an apparatus for answer feedback, which are applied to a large language model, are provided. The method includes receiving a question input by a user; generating a candidate answer set of the question by using a pre-trained large language model, and selecting an answer from the candidate answer set as a target answer, and displaying the target answer to the user; in response to receiving a feedback request for the target answer sent by the user: generating a feedback page and displaying the feedback page to the user, where content of the feedback page includes the candidate answer set; determining, in response to receiving an update request sent by the user based on the feedback page, an answer indicated by the update request from the candidate answer set as a new target answer, and displaying the new target answer to the user.

### CROSS-REFERENCE TO RELATED APPLICATIONS

This patent application claims the benefit of Chinese Patent Application No. 202311714546.9, filed on Dec. 13, 2023 and titled “Answer Feedback Method and Apparatus Applied to Large Language Model,” the entire disclosure of which is hereby incorporated by reference.

### TECHNICAL FIELD

Embodiments of the present disclosure relate to the field of data processing, and more particularly, to the field of artificial intelligence such as a generative model and an intelligent question and answer, and may be applied to a scenario in which a feedback is performed for an answer generated by a large language model.

### BACKGROUND

Large language models (LLM, Large Language Model), which are essentially generative models, such as ChatGPT (Chat Generative Pre-trained Transformer, a chat robot program developed by OpenAI), can be applied to various downstream tasks. For example, intelligent question and answer, event analysis, text generation, intelligent translation, and the like. In generative applications of the large language model, feedback for the generated results plays a vital role in the growth of large language models. More and better answer feedbacks can assist better training of the large language model, thereby providing better services for the user and forming an efficient and benign data flywheel.

Currently, in generative applications of the large language model, there are three main commonly used answer feedback modes. One is that there is no feedback. In this mode, the user can only passively receive the answers generated by the large language model, and the experience is poor. The second is to provide simple positive feedbacks and negative feedbacks such as like and dislike. This mode is only possible to learn the answer being good or bad from the feedback, and assistance for further training of the large language model is limited. Third, when the user chooses the dislike to indicate that the answer is not good, the user may fill in a specific reason by means of a window or the like. In this way, it is difficult to control the quality of the content filled in by the user, and an answer that can satisfy the user cannot be directly obtained.

### SUMMARY

Embodiments of the present disclosure propose an answer feedback method, apparatus, and storage medium applied to a large language model.

According to a first aspect, an embodiment of the present disclosure provides an answer feedback method applied to a large language model, the method including: receiving a question input by a user; generating a candidate answer set of the question using a pre-trained large language model, and selecting an answer from the candidate answer set as a target answer, and displaying the target answer to the user; in response to receiving a feedback request for the target answer sent by the user: generating a feedback page and displaying the feedback page to the user, where the content of the feedback page includes a candidate answer set; and determining, in response to receiving an update request sent by the user based on the feedback page, an answer indicated by the update request from the candidate answer set as a new target answer, and displaying the new target answer to the user.

In a second aspect, an embodiment of the present disclosure provides an answer feedback apparatus, applied to a large language model, the apparatus including: at least one processor; and a memory in communication with the at least one processor; where the memory stores instructions executable by the at least one processor, the instructions when executed by the at least one processor cause the at least one processor to perform the method as described in the first aspect.

In a third aspect, an embodiment of the present disclosure provides a non-transitory computer-readable storage medium storing computer instructions for causing a computer to perform the method as described in the first aspect.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

Other features, objectives, and advantages of the present disclosure will become more apparent by reading detailed description of non-limiting embodiments with reference to the following accompanying drawings:

FIG. 1 is an example system architecture diagram in which the present disclosure may be applied;

FIG. 2 is a flowchart of an answer feedback method applied to a large language model according to an embodiment of the present disclosure;

FIG. 3a-3c is a schematic diagram of an application scenario of an answer feedback method applied to a large language model according to an embodiment of the present disclosure;

FIG. 4a-4c is a schematic diagram of yet another application scenario of an answer feedback method applied to a large language model according to an embodiment of the present disclosure;

FIG. 5 is a flowchart of an answer feedback method applied to a large language model according to another embodiment of the present disclosure;

FIG. 6a-6c is a schematic diagram of a closed loop in which answer feedback is obtained and a training is performed based on the answer feedback;

FIG. 7 is a schematic structural diagram of an answer feedback device applied to a large language model according to an embodiment of the present disclosure;

FIG. 8 is a block diagram of an electronic device adapted to to implement the answer feedback method applied to a large language model according to an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description.

It should be noted that, the embodiments in the present disclosure and features in the embodiments may be combined with each other on a non-conflict basis. The present disclosure will now be described in detail with reference to the accompanying drawings and examples.

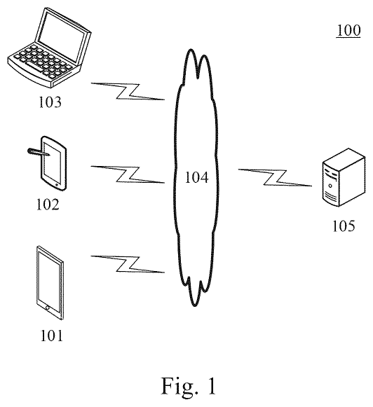

FIG. 1 illustrates an example system architecture 100 in which an embodiment of an answer feedback method applied to a large language model or an answer feedback apparatus applied to a large language model of the present disclosure may be applied.

As shown in FIG. 1, the system architecture 100 may include terminal devices 101, 102, 103, a network 104, and a server 105. The network 104 serves as a medium for providing a communication link between the terminal devices 101, 102, 103 and the server 105. Network 104 may include various types of connections, such as wired, wireless communication links, or fiber optic cables, among others.

The user may interact with the server 105 through the network 104 using the terminal devices 101, 102, 103 to receive or send messages, etc. The terminal devices 101, 102, 103 and the server 105 may be provided with various applications for implementing information communication between the terminals and the server, such as search applications, model training applications, and the like.

The server 105 may provide various services to the terminal devices 101, 102, 103. For example, the server 105 may receive a question input by a user of the terminal devices 101, 102, 103, generate a candidate answer set of the question using a pre-trained large language model, select an answer from the candidate answer set as a target answer and display the answer, may also receive a feedback request sent by the user for the target answer, generate a feedback page including the candidate answer set, and upon receiving an update request sent by the user based on the feedback page, may determine an answer indicated by the update request in the candidate answer set as a new target answer and display the answer.

The terminal devices 101, 102, 103 may be hardware or software. When the terminal devices 101, 102, 103 are hardware, they may be various electronic devices having a display screen, including but not limited to a smartphone, a tablet computer, a laptop computer, a desktop computer, and the like; and when the terminal devices 101, 102, and 103 are software, the terminal devices 101, 102, and 103 may be installed in the electronic devices listed above, and may be implemented as a plurality of software pieces or software modules, or may be implemented as a single software piece or software module, which is not specifically limited herein.

The server 105 may be hardware or software. When the server 105 is hardware, a distributed server cluster composed of multiple servers may be implemented, or a single server may be implemented; and when the server is software, the server may be implemented as a plurality of software pieces or software modules, or may be implemented as a single software piece or software module, which is not specifically limited herein.

It should be understood that the number of terminal devices, networks and servers in FIG. 1 is merely illustrative. There may be any number of terminal devices, networks, and servers as desired for implementation.

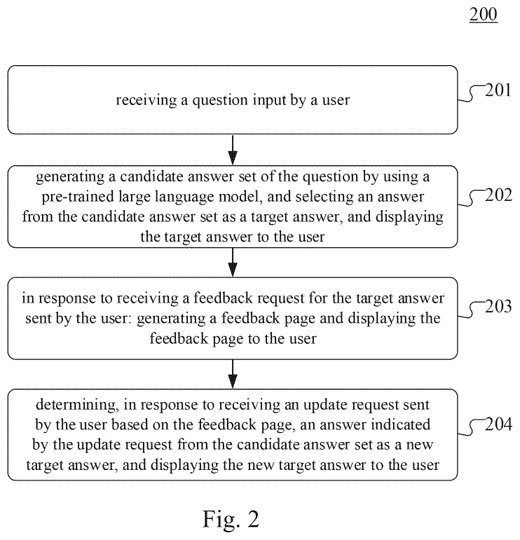

With continuing reference to FIG. 2, a flow diagram 200 of an embodiment of an answer feedback method applied to a large language model according to the present disclosure is shown. The answer feedback method for a large language model includes the steps 201 to 204.

Step 201 includes: receiving a question input by a user.

In the present embodiment, a user may input a question to an execution body (such as the server 105 shown in FIG. 1) through a terminal (such as the terminal devices 101, 102, 103 shown in FIG. 1) used by the user.

The questions entered by the user may be various questions for obtaining answers desired by the user according to actual requirements. For example, the question may be “what is a fast pulse rate”. For another example, the question may be a request for an analysis result of a designated security event.

Depending on different application scenarios, the user may use various ways to input questions, such as text input, voice input, and the like.

Step 202 includes: generating a candidate answer set of the question by using a pre-trained large language model, and selecting an answer from the candidate answer set as a target answer, and displaying the target answer to the user.

In this embodiment, the large language model may be obtained by pre-training. The large language model may generate a candidate answer set corresponding to an input question. The candidate answer set may be consisted of multiple answers.

Further, the large language model may select an answer as a target answer from the generated candidate answer set in various ways, and display the target answer to the user. For example, the answer may be randomly selected as the target answer.

For another example, the large language model may generate a matching degree corresponding to each answer in the candidate answer set while generating the candidate answer set. The matching degree may represent the matching degree between the answer and the question entered by the user. In general, the matching degree may be represented by the probability of each answer generated by the large language model. In this case, the answer corresponding to the largest matching degree (e.g., the largest probability, etc.) may be selected as the target answer.

Generally, the selected target answer may be displayed to the user in a presentation page. For example, the selected target answer may be displayed in a page displaying the questions entered by the user.

Step 203 includes: in response to receiving a feedback request for the target answer sent by the user: generating a feedback page and displaying the feedback page to the user.

In the present embodiment, the user may send a corresponding feedback request for the target answer according to the demand. The feedback request may indicate that the user has a feedback demand for the current target answer. In particular, depending on the application scenario and requirements, the user may send feedback requests in various ways. For example, a preset keyword is said by voice or a designated sentence (e.g., “feedback” or the like) is input, and the like.

After receiving the feedback request for the currently displayed target answer, the execution body may generate a corresponding feedback page and display the corresponding feedback page to the user. The content on the feedback page may include a set of candidate answers generated by the large language model for questions entered by the user.

In some cases, since content that can be displayed in a page is limited or the content of the answer is long, keywords and the like corresponding to each answer in the candidate answer set may be flexibly displayed on the feedback page without displaying the whole content of the answers.

Step 204 includes: determining, in response to receiving an update request sent by the user based on the feedback page, an answer indicated by the update request from the candidate answer set as a new target answer, and displaying the new target answer to the user.

In this embodiment, the user may send an update request for the feedback page as required. The update request may indicate that the user wishes to replace the currently displayed answer with other answers in the candidate answer set. In particular, depending on the application scenario and requirements, the user may send an update request in various ways. For example, a preset keyword is said by voice, or a specified sentence (e.g., “update”) is entered, etc.

Generally, when sending an update request, the user may designate a satisfied answer by a page intersection from a candidate answer set displayed on a feedback page. In this case, after receiving the update request sent by the user for the feedback page, the above-mentioned execution body may take the answer designated by the user as the new target answer and display the answer to the user. For example, a new target answer is shown below the previous target answer.

In the existing technology, a user can only feed back good or bad for the answer, or input a reason why the answer is not good. However, the answer feedback method of the present disclosure may, when the user is not satisfied with the current answer, interactively display to the user all candidate answers generated by the large language model for the questions input by the user, so that the user can select a satisfied answer from these answers. Compared with the existing technology, it is possible to obtain a definite, correct and user-satisfactory feedback answer, thereby effectively improving the accuracy of the user feedback.

In some alternative implementations of the present embodiment, the content of the feedback page may further include a matching degree corresponding to each answer in the candidate answer set. The matching degree is the matching degree between the answer generated by the large language model and the question input by the user.

Alternatively, the content of the feedback page may also include reference information corresponding to each answer in the candidate answer set. The reference information generally denotes information referred to or used by the large language model in generating the answer.

When the answers are displayed on the feedback page, the matching degree, reference information, and the like corresponding to each answer may be displayed in an interface, thereby facilitating a user to more accurately understand the answer-related information.

In some alternative implementations of the present embodiment, the display page to which the target answer belongs may be simultaneously displayed with a preset feedback identifier. In this case, the user may trigger the transmission of the feedback request through the interactive operation on the feedback identifier.

The feedback identifier may be pre-designed by the relevant technician. For example, the feedback identifier may be a specified pattern or the like. Generally, the page area in which the feedback identifier is located may be designed as an interactive area, such as a button control in a page. The interactive operation may also be preset (e.g., clicking, sliding in a preset direction, etc.). For example, the user may send a feedback request by clicking on the feedback identifier.

Alternatively, an update identifier may be displayed on the feedback page. In this case, the user may trigger the transmission of the update request through the interactive operation on the update identifier.

The update identifier may be pre-designed by the relevant technician. For example, the update identifier may be designated text (e.g., update answer etc.). Generally, the page area in which the update identifier is located may be designed as an interactive area, such as a button control in a page. The interactive operation may alternatively be preset (e.g., clicking, sliding in a preset direction, etc.). For example, the user may send an update request by clicking the update identifier.

The feedback page may also be displayed with a cancel identifier. In this case, in response to receiving the cancel request sent by the user for the feedback page, the display page in which the target answer is located is returned. The user may trigger the sending of the cancel request by an interactive operation on the cancel identifier.

The cancel identifier may be pre-designed by the relevant technician. For example, the cancel identifier may be designated text (e.g., “return”, etc.). Generally, the page area in which the cancel identifier is located may be designed as an interactive area, such as a button control in a page. The interactive operation may alternatively be preset (e.g., clicking, sliding in a preset direction, etc.). For example, the user may send a cancel request by clicking the cancel identifier.

Depending on the actual application requirements, various information may also be displayed on the display page and the feedback page to which the target answer belongs. For example, the display page to which the target answer belongs may also display identifiers indicating operations such as copy, refresh, forwarding, etc., so that the user may conveniently perform various operations such as copy, refresh, and forwarding of the displayed target answer.

Various interactive identifiers are displayed on the display page of the target answer and the feedback page for the target answer, so that a user can give feedback for the target answer, submit a new target answer, or give up updating the target answer according to requirements, and the like, thereby improving the user operation experience.

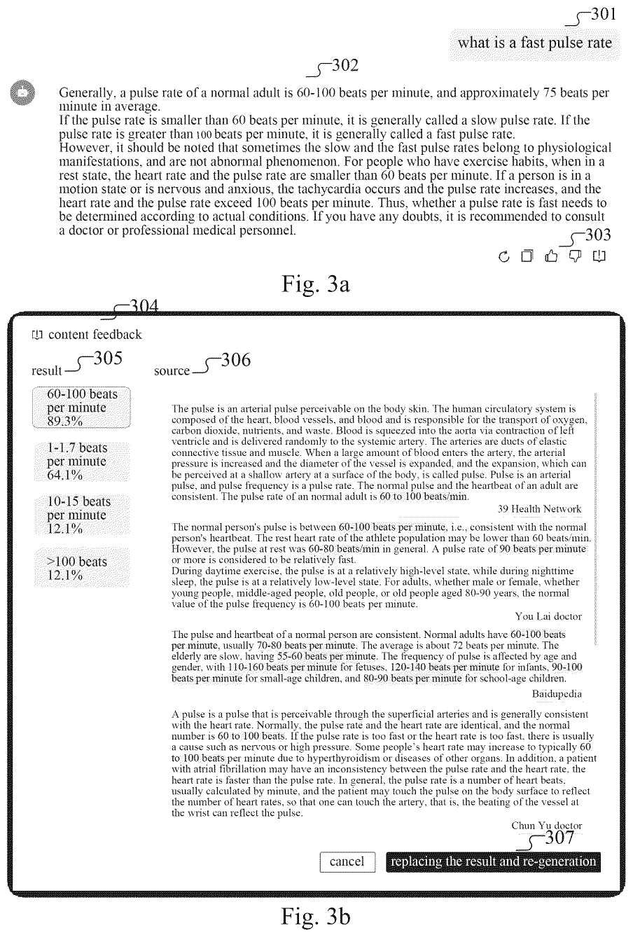

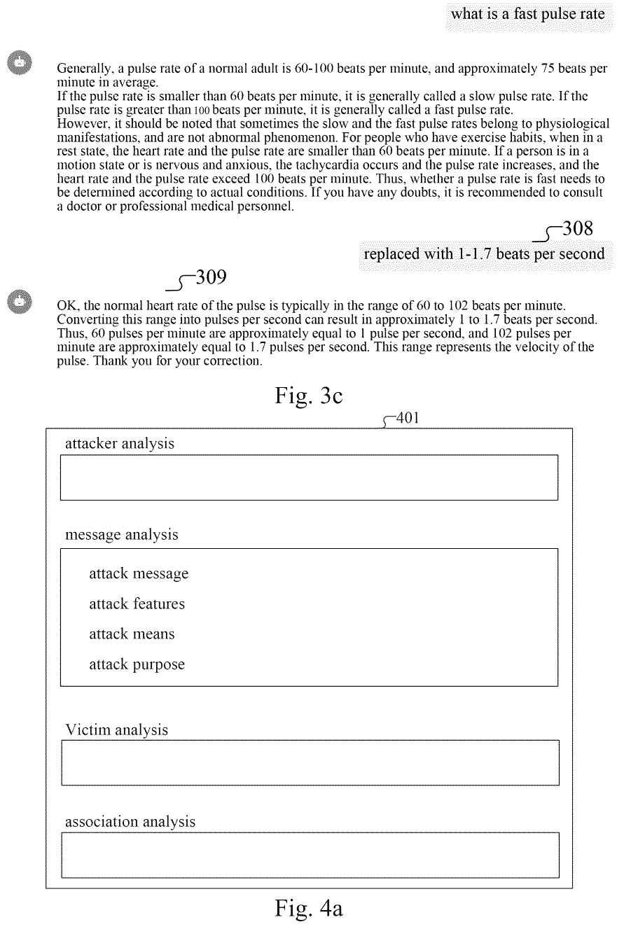

With continued reference to FIGS. 3a-3c, an illustrative application scenario of an answer feedback method applied to a large language model according to the present embodiment is shown. In FIG. 3a, the user may first input question 301 “what is a fast pulse rate”, the large language model may generate a candidate answer set corresponding to the question and a probability corresponding to each answer in the candidate answer set, and display the answer with the highest probability as the target answer (reference number 302 in the figure) to the user.

At the same time, the display page may have five operation identifiers 303, which in turn represent refresh, copy, like, dislike, and feedback. If the user is not satisfied with the current answer or wants to view more answers, the feedback page 304 may be viewed by clicking the feedback identifier in the operation identifiers 303.

In FIG. 3b, the keywords 305 corresponding to answers are sequentially displayed in a descending order of corresponding probabilities on the left side of the feedback page 304. The right side of the feedback page 304 shows the source and specific content 306 corresponding to the answer in the selected state on the left side, while highlighting the keywords corresponding to the answer. The lower right corner of the feedback page 304 displays the cancel button and button 307 for replacing the result and re-generation. The user may return to the display page shown in FIG. 3a by clicking the cancel button to abandon the modification of the target answer.

The user may alternatively select a satisfactory keyword (e.g., 1-1.7/sec) from the answer keywords displayed on the left side of the feedback page 304, and click the button for replacing the result and re-generation to send an update request for the target answer 302.

In this case, as shown in FIG. 3C, in the display page shown in FIG. 3a, “replaced with 1-1.7/sec” 308 may be automatically input, and the corresponding answer 309 may be displayed, that is, the answer keyword is combined with a preset prompt to obtain the corresponding answer.

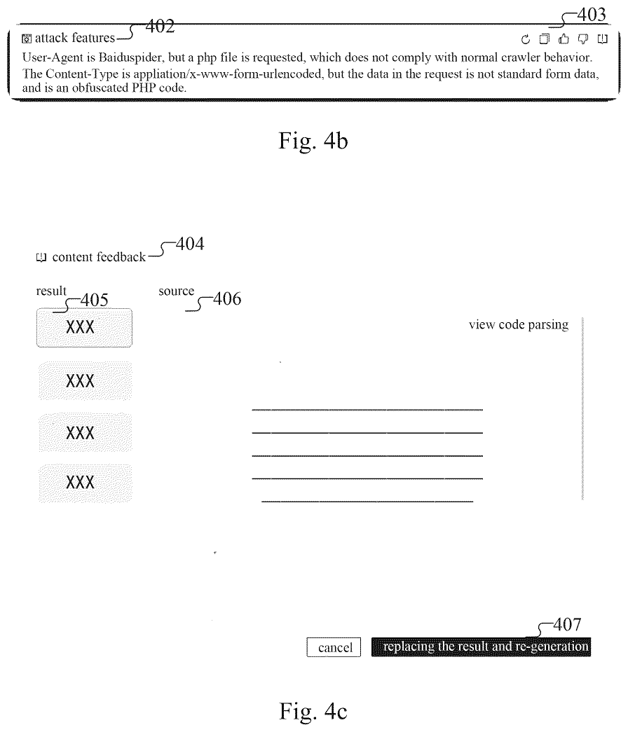

With continued reference to FIGS. 4a-4c, another illustrative application scenario of an answer feedback method applied to a large language model is shown according to the present embodiment. Questions input by security experts may request analysis of a designated security event. In this case, the large language model may analyze the security event. As shown on page 401 in FIG. 4a, attacker analysis, message analysis (attack message, attack feature, attack means, attack purpose, etc.), victim analysis, association analysis, etc., are performed on the security event.

The security expert may view specific analysis results by clicking the analysis area in page 401. As shown in FIG. 4B, after the user clicks the area corresponding to the attack analysis, a specific attack feature 402 may be displayed to the security expert, and five operation identifiers 403 are displayed at the same time, indicating refresh, copy, like, dislike, and feedback in sequence.

After the security expert clicks the feedback identifier, the feedback page 404 may be displayed to the security expert. The keywords 405 of the analysis result are shown in a descending order of corresponding probabilities on the left side of the feedback page 404. Code parsing related content 406 (e.g., original message and corresponding parsed code, etc.) in the process of generating an analysis result is shown on the right side of the feedback page 404. At the same time, the lower right corner of the feedback page 404 displays the cancel button and the button 407 for replacing the result and re-generation. The security expert may return to the display page shown in FIG. 4a by clicking the cancel button to abandon the modification of the analysis result.

Then, the security expert may perform analysis and determination according to the professional knowledge and experience, select the keyword of the correct analysis result on the left side of the feedback page, and click the button for replacing the result and re-generation on the lower right corner, so that the corresponding new analysis result may be generated for the security expert to view.

In some alternative implementations of the present embodiment, the large language model may be trained by the following steps.

Step 1 includes obtaining a pre-training basic model.

In this step, a basic model may be pre-trained. For example, based on a designated model architecture, a large amount of unlabeled data is used to perform training to obtain a base model.

Step 2 includes performing supervised fine-tuning training on the basic model to obtain a supervised fine-tuning model.

In this step, a supervised fine-tuning model may be obtained by supervised fine-tuning training of the base model using some high-quality question-and-answer data (e.g., prompt-response data pair).

Step 3 includes obtaining a pre-training reward model.

In this step, three different responses may be set for a given prompt, and the qualities are labeled, thereby forming a data set. The data set may then be used to train a reward model to learn which one of the responses is better for the given prompt.

Step 4 includes: obtaining the large language model through reinforcement learning training based on the supervised fine-tuning model and the reward model.

In this step, a large language model, au be trained by reinforcement learning using the supervised fine-tuning model and the reward model. For example, the supervised fine-tuning model may be trained to generate answers and can distinguish between good and bad answers, and the supervised fine-tuning model may be adjusted according to the positive and negative values of the reward function indicated by the reward model. The large language model is obtained by repeatedly performing this training process.

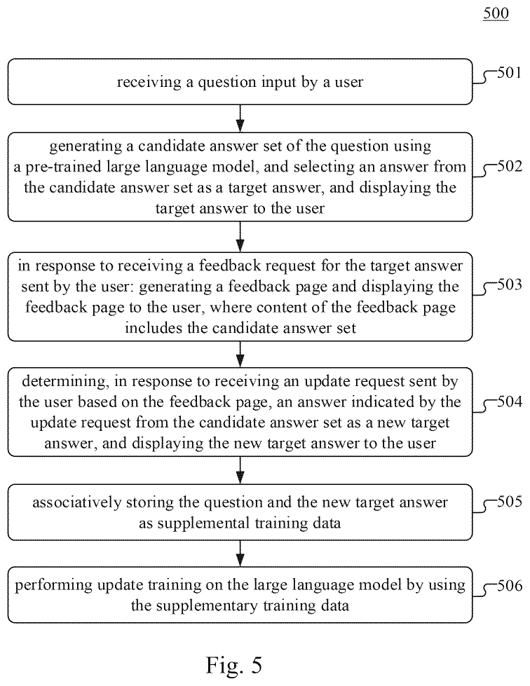

Referring further to FIG. 5, a flow 500 of yet another embodiment of an answer feedback method applied to a large language model is illustrated. The flow 500 of the answer feedback method applied to the large language model includes the steps of 501 to 506.

Step 501 includes: receiving a question input by a user.

Step 502 includes: generating a candidate answer set of the question using a pre-trained large language model, and selecting an answer from the candidate answer set as a target answer, and displaying the target answer to the user.

Step 503 includes: in response to receiving a feedback request for the target answer sent by the user: generating a feedback page and displaying the feedback page to the user, where content of the feedback page includes the candidate answer set.

Step 504 includes: determining, in response to receiving an update request sent by the user based on the feedback page, an answer indicated by the update request from the candidate answer set as a new target answer, and displaying the new target answer to the user.

Step 505 includes: associatively storing the question and the new target answer as supplemental training data.

In the present embodiment, after obtaining the new target answer, the question input by the user and the new target answer may be further stored in association as supplementary training data.

Step 506 includes: performing update training on the large language model by using the supplementary training data.

In the present embodiment, the stored supplementary training data may be used to perform further optimization training or the like on the large language model. Generally, after a certain amount of supplementary training data is reached, further optimization training is performed on the large language model.

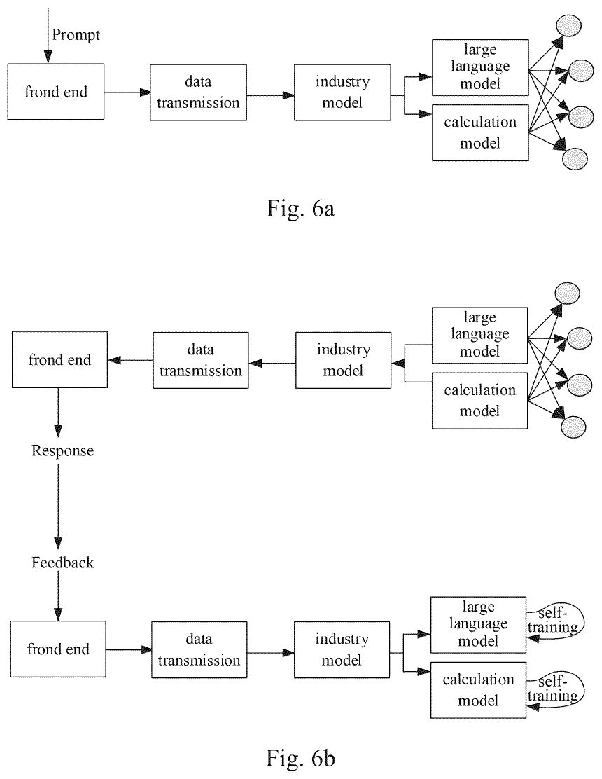

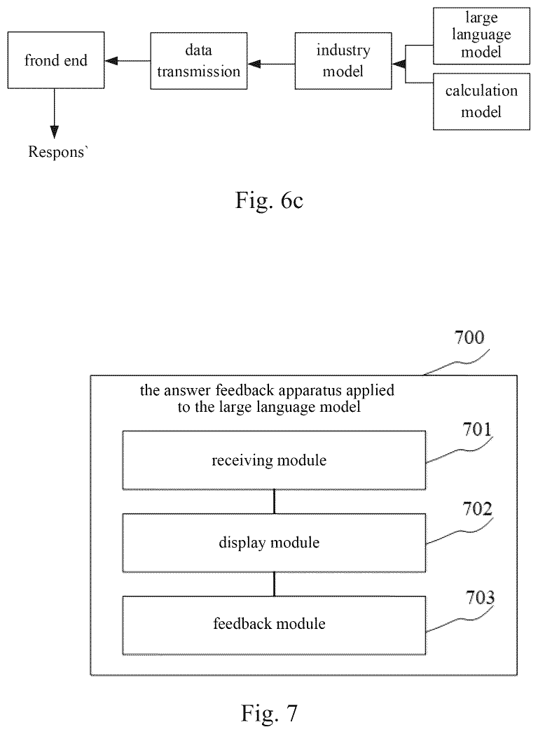

With continuing reference to FIGS. 6a-6c, a closed-loop example of one process of obtaining answer feedback and performing training based on the answer feedback is shown. The front end may be used for displaying various information. Data transmission may be used for data transmission between different modules. The industry model may be a vertical model of a given domain, capable of accurately interpreting some professional words and the like within the given domain. Computational models perform calculation in conjunction with large language models to generate answers.

In FIG. 6a, the front-end module may receive the question input by the user, the data transmission model transmits the question and the prompt to the industry model, and the industry model distributes the question and the prompt to the large-language model and the calculation model so that the large-language model and the calculation model cooperate to obtain the response by calculation.

Accordingly, in FIG. 6b, the response may be transmitted to the industry model first, and then the data transmission module transmits the response to the front-end module for display. If the user gives feedback through the feedback entry. As shown in FIG. 6c, the large language module and the calculation model may regenerate the response corresponding to the feedback and transmit through the industry model and the data transmission module in sequence to the front-end module for display to the user. Meanwhile, as shown in FIG. 6b, the large language model and the calculation model may be self-trained according to user feedback.

By recording the definite and correct answers actively fed back by the user as the training data, the large language model may be continuously adjusted and corrected in the use process of the user, and the training effect of the model can be improved.

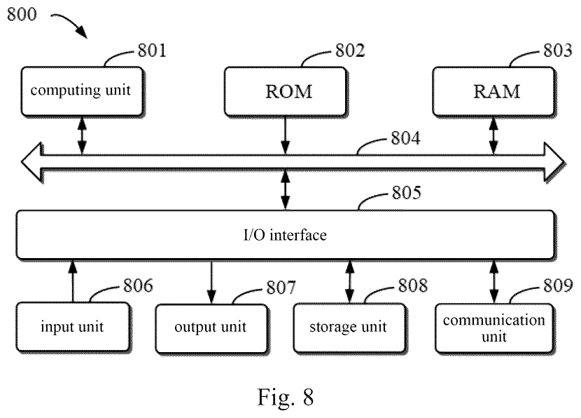

With further reference to FIG. 7, as an implementation of the method shown in above figures, the present disclosure provides an embodiment of an answer feedback apparatus applied to a large language model, which corresponds to the method embodiment shown in FIG. 2, and which is particularly applicable to various electronic devices.

As shown in FIG. 7, the answer feedback apparatus 700 applied to the large language model provided in this embodiment includes a receiving module 701, a display module 702, and a feedback module 703. The receiving module 701 is configured to receive a question input by a user. The display module 702 is configured to generate a candidate answer set of the question by using a pre-trained large language model, select an answer from the candidate answer set as a target answer, and display the target answer to the user. The feedback module 703 is configured to in response to receiving a feedback request for the target answer sent by the user: generate a feedback page and display the feedback page to the user, where content of the feedback page includes the candidate answer set. The display module 702 is further configured to, determine, in response to receiving an update request sent by the user based on the feedback page, an answer indicated by the update request from the candidate answer set as a new target answer, and display the new target answer to the user.

In the present embodiment, the specific processing of the receiving module 701, the display module 702, and the feedback module 703, and the technical effects thereof, which are applied to the answer feedback apparatus 700 of the large language model, may refer to the respective related descriptions of steps 201-204 in the corresponding embodiment in FIG. 2, and details are not described herein again.

In some alternative implementations of the present embodiment, the content of the feedback page further includes a matching degree between each answer in the candidate answer set and the question, where the matching degree is generated by the large language model.

In some alternative implementations of the present embodiment, the content of the feedback page further includes reference information corresponding to answers in the candidate answer set, where the large language model generates the candidate answer set using the reference information.

In some alternative implementations of the present embodiment, a preset feedback identifier is displayed on the display page to which the target answer belongs; and the feedback request is sent by an interactive operation of the user on the feedback identifier.

In some alternative implementations of the present embodiment, an update identifier and a cancel identifier are displayed on the feedback page; and the update request is sent by an interactive operation of the user on the update identifier; and the display module 702 is further configured to return, in response to receiving the cancel request sent by the user for the feedback page, a display page in which the target answer is located, where the cancel request is sent by an interactive operation of the user on the cancel identifier.

In some alternative implementations of the present embodiment, the large language model is trained by obtaining a pre-trained basic model; performing supervised fine-tuning training on the basic model to obtain a supervised fine-tuning model; obtaining a pre-trained reward model; and based on the supervised fine-tuning model and the reward model, obtaining a large language model through reinforcement learning training.

In some alternative implementations of the present embodiment, the apparatus further includes a storage module (not shown) configured to associatively store the question and the new target answer as supplemental training data; and a training module (not shown) configured to perform update training on the large language model by using the supplementary training data.

According to an embodiment of the present disclosure, the present disclosure also provides an electronic device, a readable storage medium, and a computer program product.

FIG. 8 illustrates a schematic block diagram of an example electronic device 800 that may be adapted to implement embodiments of the present disclosure. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 8, the apparatus 800 includes a computing unit 801, which may perform various appropriate actions and processes according to a computer program stored in a read-only memory (ROM) 802 or a computer program loaded into a random access memory (RAM) 803 from a storage unit 808. In RAM 803, various programs and data required for operation of the device 800 may also be stored. The computing unit 801, ROM 802 and RAM 803 are connected to each other via a bus 804. An input/output (I/O) interface 805 is also connected to bus 804.

A plurality of components in the device 800 are connected to the I/O interface 805, including an input unit 806, such as a keyboard, a mouse, and the like; an output unit 807, such as various types of displays, speakers, and the like; a storage unit 808, such as a magnetic disk, an optical disk, or the like; and a communication unit 809, such as a network card, a modem, or a wireless communication transceiver. The communication unit 809 allows the device 800 to exchange information/data with other devices over a computer network such as the Internet and/or various telecommunications networks.

The computing unit 801 may be various general-purpose and/or special-purpose processing components having processing and computing capabilities. Some examples of computing unit 801 include, but are not limited to, central processing units (CPUs), graphics processing units (GPUs), various specialized artificial intelligence (AI) computing chips, various computing units that run machine learning model algorithms, digital signal processors (DSPs), and any suitable processors, controllers, microcontrollers, and the like. The calculation unit 601 performs various methods and processes described above, such as an answer feedback method applied to a large language model. For example, in some embodiments, the answer feedback method applied to the large language model may be implemented as a computer software program tangibly embodied in a machine-readable medium, such as storage unit 808. In some embodiments, some or all of the computer program may be loaded and/or installed on the device 800 via the ROM 802 and/or the communication unit 809. When the computer program is loaded into the RAM 803 and executed by the computing unit 801, one or more steps of the answer feedback method applied to the large language model described above may be performed. Alternatively, in other embodiments, the computing unit 801 may be configured to perform an answer feedback method applied to a large language model by any other suitable means (e.g., by means of firmware).

Various embodiments of the systems and technologies described above can be implemented in digital electronic circuit system, integrated circuit system, field programmable gate array (FPGA), application specific integrated circuit (ASIC), application special standard product (ASSP), system on chip (SOC), complex programmable logic device (CPLD), computer hardware, firmware, software, and/or combinations thereof. These various embodiments may include being implemented in one or more computer programs that may be executed and/or interpreted on a programmable system including at least one programmable processor, which may be a dedicated or general programmable processor that may receive data and instructions from a storage system, at least one input device, and at least one output device, and transmit data and instructions to the storage system, the at least one input device, and the at least one output device.

Program codes for implementing the method of the present disclosure may be written in any combination of one or more programming languages. These program codes may be provided to a processor or controller of a general purpose computer, special purpose computer or other programmable apparatus for data processing such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with the user, the systems and techniques described herein may be implemented on a computer having: a display device for displaying information to the user (e.g., a CRT (cathode ray tube) or LCD (liquid crystal display) monitor); a keyboard and a pointing device (e.g., mouse or trackball), through which the user can provide input to the computer. Other kinds of devices can also be used to provide interaction with users. For example, the feedback provided to the user may be any form of sensory feedback (e.g., visual feedback, auditory feedback, or tactile feedback); and the input from the user can be received in any form (including acoustic input, voice input or tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server may be a cloud server, a server of a distributed system, or a server combined with a chain of blocks.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific embodiments do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

1. An answer feedback method, applied to a large language model, the method comprising:
receiving a question input by a user;
generating a candidate answer set of the question by using a pre-trained large language model, and selecting an answer from the candidate answer set as a target answer, and displaying the target answer to the user;
in response to receiving a feedback request for the target answer sent by the user: generating a feedback page and displaying the feedback page to the user, wherein content of the feedback page includes the candidate answer set; and
determining, in response to receiving an update request sent by the user based on the feedback page, an answer indicated by the update request from the candidate answer set as a new target answer, and displaying the new target answer to the user.

2. The method according to claim 1, wherein the content of the feedback page further comprises a matching degree of each answer in the set of candidate answers to the question, wherein the matching degree is generated by the large language model.

3. The method according to claim 2, wherein the content of the feedback page further comprises reference information corresponding to answers in the candidate answer set, wherein the large language model generates the candidate answer set using the reference information.

4. The method according to claim 3, wherein a preset feedback identifier is displayed on a display page to which the target answer belongs; and
the feedback request is sent by an interactive operation of the user on the feedback identifier.

5. The method according to claim 3, wherein an update identifier and a cancel identifier are displayed on the feedback page; and
the update request is sent by an interactive operation of the user on the update identifier; and
the method further comprises:
returning, in response to receiving a cancel request sent by the user on the feedback page, a display page where the target answer is located, wherein the cancel request is sent by an interactive operation of the user on the cancel identifier.

6. The method according to claim 1, wherein the large language model is trained by:
obtaining a pre-trained basic model;
performing supervised fine-tuning training on the basic model to obtain a supervised fine-tuning model;
obtaining a pre-trained reward model; and
obtaining the large language model through reinforcement learning training based on the supervised fine-tuning model and the reward model.

7. The method according to claim 6, wherein the method further comprises:
associatively storing the question and the new target answer as supplemental training data; and
performing update training on the large language model by using the supplemental training data.

8. An answer feedback apparatus, applied to a large language model, the apparatus comprising:
at least one processor; and
a memory in communication with the at least one processor;
wherein the memory stores instructions executable by the at least one processor, and the instructions when executed by the at least one processor cause the at least one processor to perform operations comprising:
receiving a question input by a user;
generating a candidate answer set of the question by using a pre-trained large language model, and selecting an answer from the candidate answer set as a target answer, and display the target answer to the user;
in response to receiving a feedback request for the target answer sent by the user: generating a feedback page and displaying the feedback page to the user, wherein content of the feedback page includes the candidate answer set; and
determining, in response to receiving an update request sent by the user based on the feedback page, an answer indicated by the update request from the candidate answer set as a new target answer, and displaying the new target answer to the user.

9. The apparatus according to claim 8, wherein the content of the feedback page further comprises a matching degree of each answer in the set of candidate answers to the question, wherein the matching degree is generated by the large language model.

10. The apparatus according to claim 9, wherein the content of the feedback page further comprises reference information corresponding to answers in the candidate answer set, wherein the large language model generates the candidate answer set using the reference information.

11. The apparatus according to claim 10, wherein a preset feedback identifier is displayed on a display page to which the target answer belongs; and
the feedback request is sent by an interactive operation of the user on the feedback identifier.

12. The apparatus according to claim 10, wherein an update identifier and a cancel identifier are displayed on the feedback page; and
the update request is sent by an interactive operation of the user on the update identifier; and
the operations further comprise: returning, in response to receiving a cancel request sent by the user on the feedback page, a display page where the target answer is located, wherein the cancel request is sent by an interactive operation of the user on the cancel identifier.

13. The apparatus according to claim 8, wherein the large language model is trained by:
obtaining a pre-trained basic model;
performing supervised fine-tuning training on the basic model to obtain a supervised fine-tuning model;
obtaining a pre-trained reward model; and
obtaining the large language model through reinforcement learning training based on the supervised fine-tuning model and the reward model.

14. The apparatus according to claim 13, wherein the operations further comprise:
associatively storing the question and the new target answer as supplemental training data; and
performing update training on the large language model by using the supplemental training data.

15. (canceled)

16. A non-transitory computer-readable storage medium storing computer instructions for causing a computer to perform operations comprising:
receiving a question input by a user;
generating a candidate answer set of the question by using a pre-trained large language model, and selecting an answer from the candidate answer set as a target answer, and display the target answer to the user;
in response to receiving a feedback request for the target answer sent by the user: generating a feedback page and displaying the feedback page to the user, wherein content of the feedback page includes the candidate answer set; and
determining, in response to receiving an update request sent by the user based on the feedback page, an answer indicated by the update request from the candidate answer set as a new target answer, and displaying the new target answer to the user.

17. (canceled).

18. The storage medium according to claim 16, wherein the content of the feedback page further comprises a matching degree of each answer in the set of candidate answers to the question, wherein the matching degree is generated by the large language model.

19. The storage medium according to claim 18, wherein the content of the feedback page further comprises reference information corresponding to answers in the candidate answer set, wherein the large language model generates the candidate answer set using the reference information.

20. The storage medium according to claim 19, wherein a preset feedback identifier is displayed on a display page to which the target answer belongs; and
the feedback request is sent by an interactive operation of the user on the feedback identifier.

21. The storage medium according to claim 19, wherein an update identifier and a cancel identifier are displayed on the feedback page; and
the update request is sent by an interactive operation of the user on the update identifier; and
the operations further comprise: returning, in response to receiving a cancel request sent by the user on the feedback page, a display page where the target answer is located, wherein the cancel request is sent by an interactive operation of the user on the cancel identifier.

22. The storage medium according to claim 16, wherein the large language model is trained by:
obtaining a pre-trained basic model;
performing supervised fine-tuning training on the basic model to obtain a supervised fine-tuning model;
obtaining a pre-trained reward model; and
obtaining the large language model through reinforcement learning training based on the supervised fine-tuning model and the reward model.
